(19) United States
(12) Patent Application Publication
(10) Pub. No.: US 2007/0056996 A1
(43) Pub. Date: Mar. 15, 2007

(54) Beverage container

(76) Inventors: Liang Zijing, Guangzhou (CN); Bentivoglio Pasquale, Reggio Calabria (IT)

Correspondence Address: John Chen;Room 303, 3F., No 25, Sec. 1, Changan E. Road, Taipei, 10441, TW

(21) Appl. No.: 11/509,025

(22) Filed: Aug. 24, 2006

(30) Foreign Application Priority Data
Sep. 15, 2005 (CN) 200510037256.0

(51) Int. Cl. B67D 3/00

(52) U.S. Cl. 222/530

(57) ABSTRACT

The present invention discloses a kind of beverage container, which is composed of a container body, a container cap, a container opening formed on the container cap and a finger grip erected on the container cap. Its characteristic is that the beverage container is equipped with a telescopic tube inside the beverage container near the underside of the container opening. The central chamber of the telescopic tube communicates with the container opening and container body; the periphery of the lower orifice of the telescopic tube is connected with the container body, and the diameter of the upper orifice is smaller than that of the container opening.When the beverage is poured out from inside the beverage container, the drink comes out through the telescopic tube. Since the telescopic tube is kept in the central chamber of the beverage container all the time without exposure to the outside environment before the beverage container is opened, the beverage will not be contaminated with the dusts at the container opening or on the container cap when it is poured out, and thus the hygiene of the beverage container be ensured to the maximum extent when it is drunk.

### FIELD OF THE INVENTION

The present invention relates to a kind of beverage packing, and more particularly, to a beverage container.

### DESCRIPTION OF THE RELATED ART

Generally, a beverage container, comprising: a container body, a container cap, a container opening formed on the container cap and a finger grip erected on the container cap. For drinking of the beverage, it is very convenient to open the container by pulling the container cap through the finger grip. However, the gap between the periphery of the container opening, the container cap and the container body of the beverage container of this kind of structure is very easy to accumulate dirt such as dust, etc., and it is very unhealthful when the container opening is opened and the beverage is poured out while the beverage is contaminated with the dusts and dirt, unless the container cap, container opening and container body are cleaned before the container cap is pulled for beverage drinking. Moreover, most people will put their lips clinging to the container opening and container body to drink the beverage, and it is even more unhealthful.

### SUMMARY OF THE INVENTION

Therefore, the present invention has been made in an effort to solve the above-described problems.

The objective of the present invention to provide a beverage container that can ensure the maximum extent of drinking sanitation.

The objective of the present invention is to be realized by means of the following technical program.

The beverage container of the present invention is composed of a container body, a container cap, a container opening formed on the container cap and a finger grip erected on the container cap. Its characteristic is that the beverage container is equipped with a telescopic tube which can be elongated and also be shortened inside the beverage container near the underside of the container opening. The central chamber of the telescopic tube communicates with the container opening and container body; the periphery of the lower orifice of the telescopic tube is connected with the container body, and the diameter of the upper orifice is smaller than that of the container opening. When the container opening is opened by means of the finger grip, the telescopic tube will bounce up automatically due to its own springiness and stick out of the container opening, or it will need to be pulled lightly by hand and you can drink the beverage through it hygienically and safely.

The present invention can be improved as follows:

The telescopic tube is equipped with a draw ring, by means of which the telescopic tube can be pulled up more conveniently and hygienically after the container opening is opened.

The upper orifice of the telescopic tube is equipped with a cap plug to plug the upper orifice, and the draw ring is erected on the outside surface of the cap plug. When the container opening is opened, the cap plug can also be pulled out of the upper orifice by means of the draw ring. When the beverage in the beverage container is not finished at a time, the upper orifice can be plugged again with the cap plug so that the beverage inside the beverage container can be kept hygienic continuously.

The cap plug can be connected with the telescopic tube by means of a connection strap, so that the cap plug will not depart from the beverage container even when it is pulled out of the upper orifice, which will not only ensure that the cap plug will not be missing due to misplacement, but also ensure the hygiene of the cap plug when the upper orifice is plugged up with it again.

For the convenience of the erection of the telescopic tube inside the beverage container, a flange is extended around from the outside wall of the lower orifice of the telescopic tube, and the flange is tightly stuck to the bottom of the container cap.

The size and shape of the external contour of the flange are the same as that of the bottom of the container cap.

For the convenience of pulling the telescopic tube, the telescopic tube can be a bellow type telescopic tube or a stage type multi-layered overlapped telescopic tube.

The telescopic tube belongs to flexible pipe.

The telescopic tube can be a barrel shape telescopic tube bigger at the bottom and smaller on the top, or a straight barrel shape telescopic tube.

The bottom of the container cap can be equipped with a clasp which is button up to the draw ring so that the telescopic tube can be pulled up and the cap plug can be opened together at the same time when the container cap is opened.

The beverage container is equipped with a telescopic tube inside the beverage container near the underside of the container opening. The central chamber of the telescopic tube communicates with the container opening and container body; the periphery of the lower orifice of the telescopic tube is connected with the container body. When the beverage is poured out from the beverage container, the beverage comes out through the telescopic tube. Since the telescopic tube is always inside the central chamber of the container body and is not exposed to the outside environment, the beverage will not be contaminated with the dusts at the container opening or on the container cap, and the hygiene of the beverage container be ensured to the maximum extent when it is drunk. The present invention is simple in structure, safe and reliable, and is suitable for various kinds of beverage containers.

### BRIEF DESCRIPTION OF THE DRAWINGS

FIG. 1 is a schematic diagram showing a beverage container according to a first embodiment of the present invention;

FIG. 2 is a schematic diagram showing the beverage container of FIG. 1;

FIG. 3 is a schematic diagram showing the beverage container of FIG. 2 when the container cap is opened;

FIG. 4 is a schematic diagram showing the beverage container of FIG. 1 when the telescopic tube is pulled out;

FIG. 5 is a schematic diagram showing a beverage container according to a second embodiment of the present invention;

FIG. 6 is a schematic diagram showing the beverage container of FIG. 5 when the container cap is opened and the telescopic tube is pulled out;

FIG. 7 is a schematic diagram showing the beverage container of FIG. 6 during the telescopic tube and its cap plug and draw ring is enlarged;

FIG. 8 is a schematic diagram showing the beverage container of FIG. 7 when all parts are pressed together.

### DETAILED DESCRIPTION OF THE PREFERRED EMBODIMENTS

Preferred embodiments of the present invention will be described more in detail with referent to the accompanying drawings

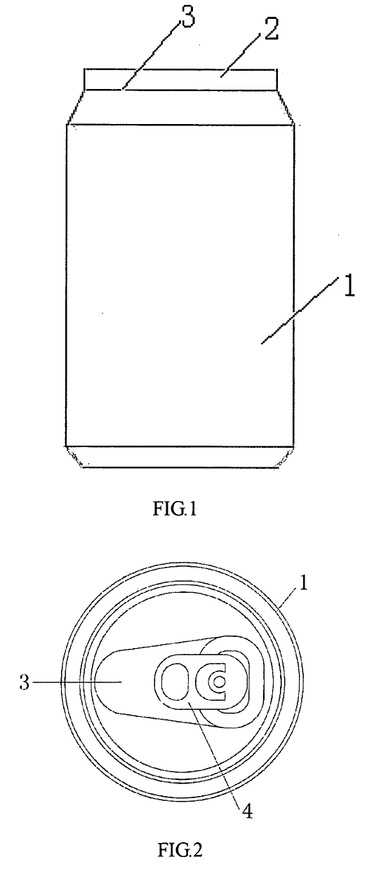

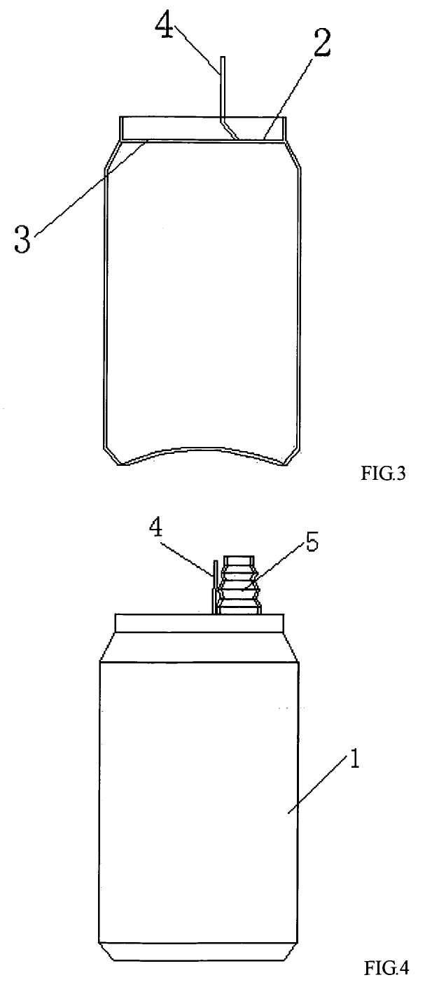

In the first embodiment, referring to FIG. 1 to 4, the beverage container of the present invention is composed of a container body 1, a container cap 3, a container opening 2 formed on the container cap 3 and a finger grip 4 erected on the container cap 3. Its characteristic is that the beverage container is equipped with a bellow type flexible telescopic tube 5 inside the beverage container near the underside of the container opening 2. The central chamber of the telescopic tube 5 communicates with the container opening 2 and the container body 1; the periphery of the lower orifice 51 of the telescopic tube 5 is connected with the container body 1, and the diameter of the upper orifice 52 is smaller than that of the container opening 2. When the container opening 2 is opened by means of the finger grip 4, the telescopic tube 5 compressed inside the container body 1 will spring up automatically due to its own springiness, and the Upper Orifice 52 will out of the container opening 2. At this time, you only have to stretch the telescopic tube 5 slightly, and you can drink the beverage hygienically and safely.

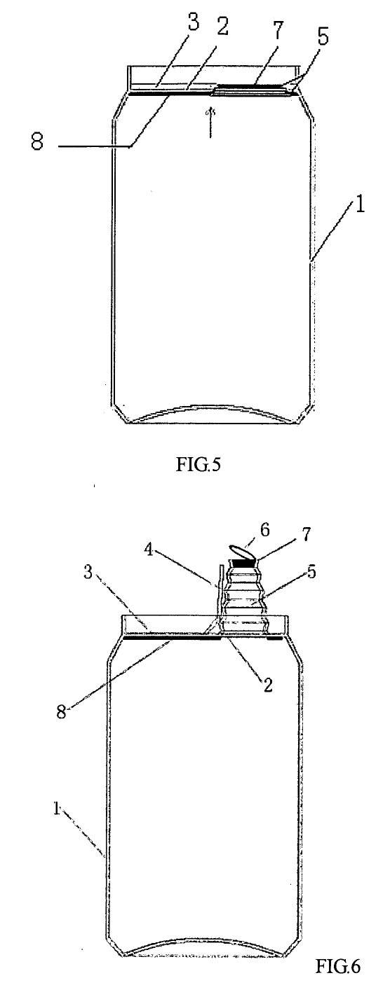

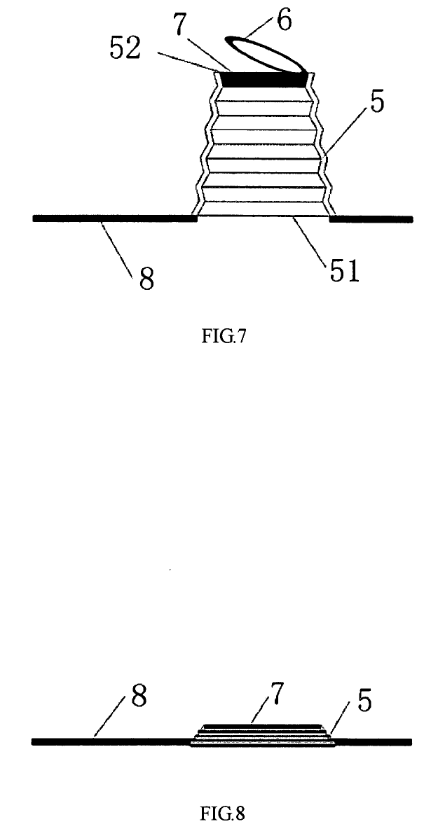

In the second embodiment, referring to FIG. 5 to 8, it is a ring-pull container composed of a container body 1, a container cap 3, a container opening 2 formed on the container cap 3 and a finger grip 4 erected on the container cap 3. Its characteristic is that the beverage container is equipped with a barrel shape flexible bellow type telescopic tube 5 inside the beverage container near the underside of the container opening 2. The central chamber of the telescopic tube 5 communicates with the container opening 2 and the container body 1; The periphery of the lower orifice 51 of the telescopic tube 5 is connected with the container body 1, and the diameter of the upper orifice 52 is smaller than that of the container opening 2; The upper orifice 52 of the telescopic tube 5 is equipped with a draw ring 6, the upper orifice 52 the telescopic tube 5 is equipped with a cap plug 7 to plug the upper orifice 52, and the draw ring 6 is erected on the outside surface of the cap plug 7; A flange 8 is extended around from the outside wall of the lower orifice 51 of the telescopic tube 5, and the size and shape of the external contour of the flange 8 are the same as that of the bottom of the container cap 3, and the flange 8 is tightly stuck to the bottom of the container cap 3. When the container cap 3 is opened, the telescopic tube 5 can be pulled out from the container body 1 by means of draw ring 6, and the cap plug 7 can also be pulled out from upper orifice 52 of the telescopic tube 5. When the beverage is not finished at a time, the upper orifice 52 can be plugged up again with cap plug 7 to keep the hygiene of the beverage inside the container continuously.

Although the preferred embodiments of the invention have been disclosed for illustration purposes, those skilled in the art will appreciate that various modifications, additions and substitutions are possible, without departing from the scope and spirit of the invention as disclosed in the accompanying claims.

What is claimed is:

1. A beverage container, comprising: a container body, a container cap, a container opening formed on the container cap and a finger grip erected on the container cap wherein the beverage container is equipped with a telescopic tube inside the beverage container near the underside of the container opening; The central chamber of the telescopic tube communicates with the container opening and container body; the periphery of the lower orifice of the telescopic tube is connected with the container body, and the diameter of the upper orifice is smaller than that of the container opening.

2. The beverage container according to claim 1, wherein the telescopic tube is equipped with a draw ring.

3. The beverage container according to claim 2, wherein the upper orifice of the telescopic tube is equipped with a cap plug to plug the upper orifice, and the draw ring is erected on the outside surface of the cap plug.

4. The beverage container according to claim 3, wherein the cap plug can be connected with the telescopic tube by means of a connection strap.

5. The beverage container according to claim 1, wherein the telescopic tube can be a bellow type telescopic tube.

6. The beverage container according to claim 1, wherein the telescopic tube can be a stage type multi-layered overlapped telescopic tube.

7. The beverage container according to claim 1, wherein The telescopic tube belongs to flexible pipe.

8. The beverage container according to claim 3, wherein the bottom of the container cap can be equipped with a clasp which is button up to the draw ring.

9. The beverage container according to claim 4, wherein the bottom of the container cap can be equipped with a clasp which is button up to the draw ring.

10. The beverage container according to claims 1, wherein a flange is extended around from the outside wall of the lower orifice of the telescopic tube, and the flange is tightly stuck to the bottom of the container cap.

11. The beverage container according to claims 2, wherein a flange is extended around from the outside wall of the lower orifice of the telescopic tube, and the flange is tightly stuck to the bottom of the container cap.

12. The beverage container according to claims 3, wherein a flange is extended around from the outside wall of the lower orifice of the telescopic tube, and the flange is tightly stuck to the bottom of the container cap.

13. The beverage container according to claims 4, wherein a flange is extended around from the outside wall of the lower orifice of the telescopic tube, and the flange is tightly stuck to the bottom of the container cap.

14. The beverage container according to claims 5, wherein a flange is extended around from the outside wall of the lower orifice of the telescopic tube, and the flange is tightly stuck to the bottom of the container cap.

15. The beverage container according to claims 6, wherein a flange is extended around from the outside wall of the lower orifice of the telescopic tube, and the flange is tightly stuck to the bottom of the container cap.

16. The beverage container according to claims 7, wherein a flange is extended around from the outside wall of the lower orifice of the telescopic tube, and the flange is tightly stuck to the bottom of the container cap.

17. The beverage container according to claim 12, wherein the size and shape of the external contour of the flange are the same as that of the bottom of the container cap.

18. The beverage container according to claim 14, wherein the size and shape of the external contour of the flange are the same as that of the bottom of the container cap.

19. The beverage container according to claim 15, wherein the size and shape of the external contour of the flange are the same as that of the bottom of the container cap.

20. The beverage container according to claim 16, wherein the size and shape of the external contour of the flange are the same as that of the bottom of the container cap.
